(19) United States
(12) Patent Application Publication
(10) Pub. No.: US 2023/0127352 A1
(43) Pub. Date: Apr. 27, 2023

(54) METHOD FOR PRODUCING A PRODUCT AND TECHNICAL PLANT

(71) Applicant: SEW-EURODRIVE GMBH & CO. KG, Bruchsal (DE)

(72) Inventors: Josef SCHMIDT, Philippsburg-Huttenheim (DE); Gero BOCKELMANN, Bruchsal (DE); Frank SCHÖNUNG, Graben-Neudorf (DE); Alexander FUCHS, Bruchsal (DE); Tanja WALZ, Walzbachtal (DE)

(73) Assignee: SEW-EURODRIVE GMBH & CO. KG, Bruchsal (DE)

(21) Appl. No.: 17/800,390

(22) PCT Filed: Feb. 4, 2021
(86) PCT No.: PCT/EP2021/052641

§ 371 Date: Aug. 17, 2022

(30) Foreign Application Priority Data
Feb. 27, 2020 (DE) 10 2020 001 272.8

(51) Int. Cl. G05B 19/418; G06Q 50/04; G06Q 10/0631; G06Q 10/08

(52) U.S. Cl. CPC G05B 19/41865; G05B 19/4189; G06Q 50/04; G06Q 10/06316; G06Q 10/08

(57) ABSTRACT

In a method for producing a product in a technical plant, after receipt of an order for producing the product, components necessary for producing the product are identified, and work steps necessary for producing the product are identified. Identified components and work steps are entered in a product file stored on a transport system. The components entered in the product file are acquired by the transport system, which is documented in the product file, and the work steps entered in the product file are executed, which is documented in the product file. The product file remains on the transport system until the acquisition of each component and the execution of each work step are documented in the product file. A technical plant for producing a product, is adapted to execute the method and includes a transport system having a digital data memory for storing the product file.

### FIELD OF THE INVENTION

The present invention relates to a method for producing a product, e.g., in a technical plant, in which, for example, after receipt of an order for producing the product, components required for producing the product are identified and work steps required for producing the product are identified. The present invention also relates to a technical plant for producing a product, which is, for example, adapted to carry out the method.

The technical plant is, e.g., an industrial application, for example, a production plant. Typically, when an order is received to produce a product, components required to produce the product and operations required to produce the product are identified. For this purpose, for example, a central server is provided in the technical plant, which processes the order and, e.g., identifies the components and work steps. Respective configurations of the products to be produced are known in the server for this purpose. Recorded components and work steps executed are reported to the server via a network, such that the server knows the current processing status of the product. The central server provides computing power, and the network provides for the transmission of the required data.

### BACKGROUND INFORMATION

A system for mass production is described in German Patent Document No. 10 2013 000 596, which has various work stations. The work stations are each configured to carry out a work step.

A system and a method for processing customer orders are described in German Patent Document No. 10 2017 005 145. Customer orders are evaluated and associated product packages are identified. Work packages are associated with the product packages, and each work package is associated with a work station for performing a work item.

Methods for producing products and technical plants provided for this purpose are also described in U.S. Patent Application Publication No. 2019/0243345, U.S. Patent Application Publication No. 2004/0084520, and PCT Patent Document No. WO 2019/234249.

### SUMMARY

Example embodiments of the present invention provide a method for producing a product in a technical plant and a technical plant for producing a product.

According to an example embodiment of the present invention, in a method for producing a product in a technical plant, after receipt of an order for producing the product, components required for producing the product are identified and work steps required for producing the product are identified. Identified components and identified work steps are entered in a product file and the product file is stored on a transport system. After the product file is stored on the transport system, the components entered in the product file are acquired by the transport system, the acquisition of each component is documented in the product file, the work steps entered in the product file are executed, and the execution of each work step is documented in the product file. The product file remains on the transport system until the acquisition of each component entered in the product file is documented in the product file and until the implementation of each work step entered in the product file is documented in the product file. This completes the producing of the product.

Identification of the components and work steps is performed by a central server, for example. However, it is not necessary to give feedback to the server over a network about the individual components that have been acquired and the individual work steps that have been executed. Feedback to the server over the network is not required until the production of the product is complete. It is sufficient that the current processing status of the product is known in the transport system. This reduces the load on the central server, and as a result the computing power to be made available by the server is lower. The amount of data transmitted over the network between the transport system and the central server is also reduced, thereby reducing the load on the network.

For example, the product is produced entirely on the transport system. The partially produced product remains on the transport system until the producing of the product is completed. All work steps are executed on the product located on the transport system, e.g., all components on the transport system are mounted to the product.

It is also possible that the partially produced product is removed from the transport system to carry out specific work steps and is placed back on the transport system after such a work step has been executed. Such a work step is a painting process, for example.

According to example embodiments, after identifying the components required to manufacture the product and after identifying the work steps required to manufacture the product, a fixed sequence is specified once for picking up the identified components and for executing the identified work steps. The fixed sequence is entered in the product file. The components entered in the product file are acquired and the work steps entered in the product file are executed in the fixed sequence until the inclusion of each component entered in the product file is documented in the product file and until the executing of each work step entered in the product file is documented in the product file.

The fixed sequence is, for example, specified by the central server, on which suitable sequences are known or created for each product to be produced. The transport system does not require any respective computing power to create such a sequence. As a result, the transport system can be implemented in a cost-effective manner.

For example, when identifying the components that are required to produce the product, at least one storage location is determined at which at least one identified component is available, and the at least one determined storage location is documented in the product file. The transport system is moved to the at least one determined storage location, and the at least one identified component is acquired at the at least one determined storage location.

When identifying the work steps required to produce the product, at least one work station is, for example, determined at which at least one work step to be executed can be executed, and the at least one work station determined is documented in the product file. The transport system is moved to the at least one determined work station and the at least one identified work step is performed at the at least one determined work station.

According to example embodiments, after the product file has been stored on the transport system, a digital computer in the transport system creates a temporary sequence for acquiring the identified components and for executing the identified work steps. Then, the component to be acquired next according to the temporary order is acquired by the transport system, or the work step to be executed next according to the temporary order is executed.

For example, the creation of a temporary sequence and the acquisition of the component to be acquired next according to the temporary sequence or the execution of the work step to be executed next according to the temporary sequence are repeated until the acquisition of each component entered in the product file is documented in the product file and until the execution of each work step entered in the product file is documented in the product file.

The digital computer of the transport system provides the respective computing power to create such a temporary sequence. Producing the product includes work steps whose sequence is variable. The sequence in which components are acquired is also partially variable. For example, it is of equal importance whether the gears or the shafts are acquired first when producing a gearbox. Repeated creation of a temporary sequence makes it possible to react immediately to unplanned events in the technical plant and thus to optimize the production of the product. Nevertheless, there are certain specifications for the temporary sequence that must be observed when the digital computer creates them. For example, a thread must first be cut into a transmission housing before a screw is screwed into it.

When creating the temporary sequence, the digital computer of the transport system, for example, determines a storage location at which the component to be acquired next according to the temporary sequence is available, and the determined storage location is documented in the product file. The transport system is moved to the determined storage location, and the component to be acquired next according to the temporary sequence is acquired at the determined storage location.

When creating the temporary sequence, the digital computer of the transport system, for example, determines a work station at which the work step to be executed next according to the temporary sequence can be executed, and the determined work station is documented in the product file. The transport system is moved to the determined work station, and the work step to be executed next according to the temporary sequence is executed at the determined work station.

According to example embodiments, the digital computer of the transport system creates the temporary sequence such that a travel path of the transport system is minimized during the production of the product and/or that a time required to produce the product is minimized. For example, operating costs of the transport system are reduced by minimizing the travel path covered by the transport system. Minimizing the amount of time to produce the product increases the productivity of the plant.

Repeated creation of a temporary sequence makes it possible to react immediately to current and/or unplanned events in the technical plant and thus to optimize the production of the product. Examples of such events are high utilization of an identified work station, temporary unavailability of an identified component, or failure of an identified work station due to a technical defect. When such an event occurs, the digital computer of the transport system creates another temporary sequence that differs from the previous temporary sequence. If no disturbing event occurs, the digital computer of the transport system keeps the previous temporary sequence.

A technical plant according to an example embodiment of the present invention for producing a product is adapted to execute the method described herein. The technical plant includes at least one transport system which has a digital data memory on which the product file can be stored.

In a technical system according to an example embodiment of the present invention, the load on the central server is, for example, reduced, and as a result the computing power to be provided by the server is lower. The amount of data transmitted over the network between the transport system and the central server is also, for example, reduced, whereby the load on the network is reduced.

According to example embodiments, the at least one transport system is configured as an autonomous vehicle that has a drive device and a control unit for controlling the drive device. The drive device includes, for example, an electric energy store, an electric motor, a transmission, and drive wheels. The transport system, which is also referred to as a driverless transport vehicle, also has a wireless communication interface for communication with a server, for example, via a wireless network.

According to example embodiments, the at least one transport system has a digital computer which is adapted to create a temporary sequence for acquiring the identified components and for executing the identified work steps. For this purpose, the digital computer includes respective software to create the temporary sequence. Repeated creation of a temporary sequence makes it possible to react immediately to unplanned events in the technical plant and thus to optimize the production of the product.

The technical plant includes, for example, at least one storage location at which at least one identified component is available, and at least one work station at which at least one identified work step can be executed. This provides for the product to be produced in the technical plant.

Further features and aspects of example embodiments of the present invention are explained in more detail below with reference to the appended schematic Figures.

### BRIEF DESCRIPTION OF THE DRAWINGS

FIG. 1 is a schematic view of a technical plant.

FIG. 2 is a schematic view of a transport system.

### DETAILED DESCRIPTION

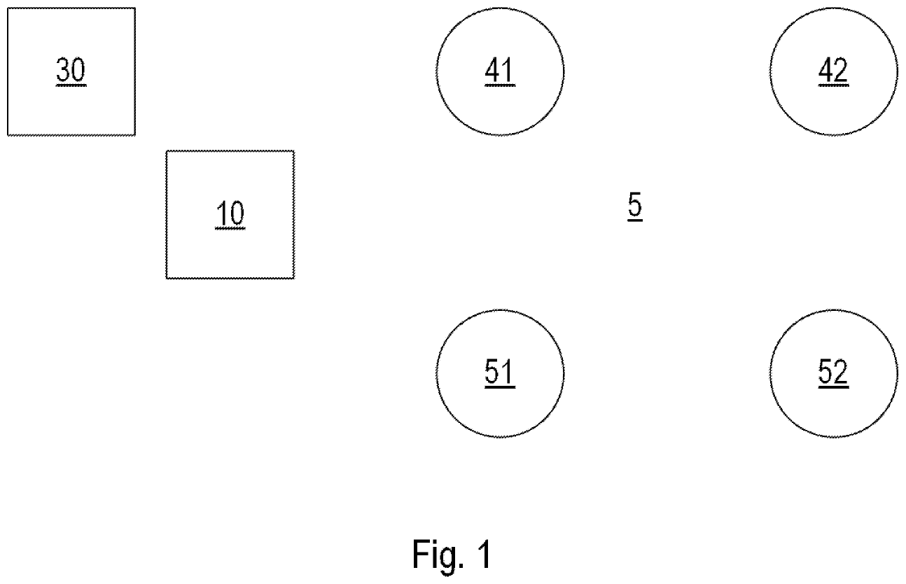

FIG. 1 is a schematic view of a technical plant 5. For example, the technical plant 5 is an industrial application, e.g., a production plant. The technical plant 5 is used to produce products, for example, to produce transmissions for electric motors. The technical plant 5 includes a central server 30 which, for example, receives and processes orders for the production of products.

The technical plant 5 includes a first storage location 41 and a second storage location 42. Components that are required for the production of a product are available at the first storage location 41 and at the second storage location 42. The components are, for example, gearbox housings, gears, shafts, or screws.

The technical plant 5 includes a first work station 51 and a second work station 52. Work steps which are necessary for the production of a product can be executed at the first work station 51 and at the second work station 52. The work steps mentioned are cutting of threads into gear housings or inserting gear wheels and shafts in a gear housing, for example.

The technical plant 5 also includes multiple transport systems 10. The transport systems 10 are autonomous vehicles, which are also referred to as driverless transport vehicles. The transport systems 10 are moved, for example, to the storage locations 41, 42 and to the work stations 51, 52. The transport systems 10 communicate with the server 30 via a wireless network.

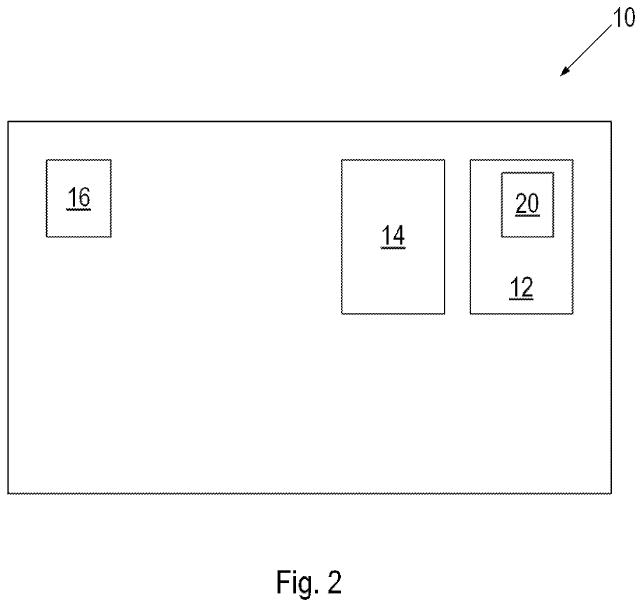

FIG. 2 is a schematic view of a transport system 10. The transport system 10 is, for example, adapted to transport a partially produced product and a fully produced product. The product can thus be produced entirely on the transport system 10.

The transport system 10 includes a digital data memory 12 for storing electronic files. The data memory 12 is used, for example, for storing product files 20. For example, a product file 20 is stored in the data memory 20, in which identified components and identified work steps are entered.

The transport system 10 includes a digital computer 14, which is used, for example, to create temporary sequences for acquiring identified components and for executing identified work steps. For this purpose, the digital computer 14 accesses the data memory 12, e.g., the product file 20. Furthermore, the digital computer 14 is used to document the execution of each work step in the product file 20 and to document the acquisition of each component in the product file 20.

The transport system 10 includes a wireless communication interface 16, which is used, for example, for communication with the server 30 via the wireless network. The transport system 10 receives the product file 20 prepared by the server 30, for example, via the communication interface 16. The transport system 10 also reports to the server 30 via the communication interface 16 when the acquisition of each component entered in the product file 20 is documented in the product file 20, and when the execution of each work step entered in the product file 20 is documented in the product file 20. The transport system 10 thus reports to the server 30 via the communication interface 16 when the production of the product is complete.

The transport system 10 includes a drive device, which has an electric energy store, an electric motor, a transmission, and drive wheels. The transport system 10 also includes a control unit for controlling the drive device. The control unit is integrated into the digital computer 14, for example.

### LIST OF REFERENCE NUMERALS

5 technical plant
10 transport system
12 data storage
14 digital calculator
16 communication interface
20 product file
30 servers
41 first storage location
42 second storage location
51 first work station
52 second work station

1-13. (canceled)

14. A method for producing a product in a technical plant, comprising:
after receiving an order for producing the product, identifying components and work steps necessary for producing the product;
entering the identified components and work steps into a product file;
storing the product file on a transport system;
acquiring, by the transport system, the components entered into the product file;
documenting, in the product file, the acquisition of each component;
executing the work steps entered into the product file; and
documenting, in the product file, the execution of each work step;
wherein the product file remains on the transport system until the acquisition of each component entered in the product file is documented in the product file, and until the execution of each work step entered in the product file is documented in the product file.

15. The method according to claim 14, wherein, after identifying the components and work steps that are necessary for producing the product, a fixed sequence for acquiring the identified components and for executing the identified work steps is specified once, and the fixed sequence is entered in the product file; and
wherein, the acquisition of the components entered in the product file and the execution of the work steps entered in the product file are performed in the fixed sequence until the acquisition of each component entered in the product file is documented in the product file, and until the execution of each work step entered in the product file is documented in the product file.

16. The method according to claim 15, wherein the identifying of the components that are necessary for producing the product includes determining at least one storage location at which at least one identified component is available, the method further comprising documenting, in the product file, the at least one determined storage location, moving the transport system to the at least one determined storage location, and acquiring the at least one identified component at the at least one determined storage location.

17. The method according to claim 15, wherein the identifying of the work steps necessary for producing the product includes determining at least one work station at which at least one work step to be executed is able to be executed and documenting, in the product file, the at least one identified work station, the method further comprising moving the transport system to the at least one identified work station and executing the at least one identified work step at the at least one identified work station.

18. The method according to claim 14, wherein, after the product file is stored on the transport system, a digital computer of the transport system creates a temporary sequence for acquiring the identified components and to execute the identified work steps, and wherein the component to be acquired next according to the temporary sequence is acquired by the transport system and/or the work step to be executed next according to the temporary sequence is executed.

19. The method according to claim 18, wherein the creation of the temporary sequence and the acquisition of the component to be acquired next according to the temporary sequence and/or the execution of the work step to be executed next according to the temporary sequence are repeated until the acquisition of each component entered in the product file is documented in the product file and until the execution of each work step entered in the product file is documented in the product file.

20. The method according to claim 18, wherein the digital computer of the transport system, when creating the temporary sequence, determines a storage location at which the next component to be acquired according to the temporary sequence is available, the determined storage location is documented in the product file, the method further comprising moving the transport system to the determined storage location acquiring, at the determined storage location, the component to be acquired next according to the temporary sequence.

21. The method according to claim 18, wherein the digital computer of the transport system, when creating the temporary sequence, determines the work station at which the next work step according to the temporary sequence is able to be executed, the determined work station is documented in the product file, the method further comprising moving the transport system to the determined work station and executing, at the determined work station, the work step to be executed next according to the temporary sequence.

22. The method according to claim 18, wherein the digital computer of the transport system creates the temporary sequence to minimize a travel path of the transport system during the production of the product and/or to minimize a period of time to produce the product.

23. A technical plant for producing a product, comprising:
at least one transport system including a digital memory adapted to store a product file;
wherein the technical plant is adapted to perform the method recited in claim 14.

24. The technical plant according to claim 23, wherein the transport system is arranged as an autonomously driving vehicle including a drive device and a control unit adapted to control the drive device.

25. The technical plant according to claim 23, wherein the transport system includes a digital computer adapted to create a temporary sequence for acquiring the identified components and for executing the identified work steps.

26. The technical plant according to claim 23, further comprising
at least one storage location at which at least one identified component is available; and
at least one work station at which at least one identified work step is executable.
